(19) United States
(12) Patent Application Publication
(10) Pub. No.: US 2026/0110843 A1
(43) Pub. Date: Apr. 23, 2026

(54) VARIABLE OPTICAL ATTENUATOR ARRAY, AND POWER ADJUSTMENT DEVICE

(71) Applicant: Huawei Technologies Co., Ltd., Shenzhen (CN)

(72) Inventor: Zhiping Jiang, Kanata (CA)

(21) Appl. No.: 18/921,928

(22) Filed: Oct. 21, 2024

(51) Int. Cl. G02B 6/26; G02B 6/35; H04B 10/2507; H04J 14/02

(52) U.S. Cl. CPC G02B 6/266; G02B 6/3512; G02B 6/3588; G02B 6/3594; H04B 10/25073; H04J 14/02216

(57) ABSTRACT

A variable optical attenuator (VOA) array is described, which may achieve a power adjustment speed of 1 ms or less for each channel. The VOA array includes: a substrate; and a plurality of VOAs disposed on the substrate, where the plurality of VOAs have trenches therebetween, and a VOA in the plurality of VOAs includes: a phase change material (PCM) layer, where a state of the PCM layer is selectively in a crystalline state, an amorphous state, or a mixed state based on temperature of the PCM layer, and variation of the state of the PCM layer is used for adjusting an output power of an optical signal input into the VOA array; a controller configured to change the temperature of the PCM layer; and a mirror layer configured to reflect the adjusted optical signal of the

### TECHNICAL FIELD

The present disclosure generally relates to the field of optical communication, and in particular to a variable optical attenuator (VOA) array and a power adjustment device.

### BACKGROUND

An optical fiber communication system is a system that uses light as the carrier of information and optical fibers as transmission media. Such a system works on the principle of total internal reflection of light in the optical fibers including a particular material (such as glass or plastic), and can achieve high-speed, high-capacity data transmission with low signal attenuation and strong anti-interference capability. In a typical optical fiber communication system, a transmitting end converts information to be transmitted into an electrical signal, modulates the electrical signal onto a laser beam emitted by a laser in the transmitting end to produce an optical signal, and then transmits the optical signal to a receiving end through an optical fiber. The receiving end converts the received optical signal into an electrical signal and demodulates the electrical signal to produce the original information.

### SUMMARY

According to a first aspect, a variable optical attenuator (VOA) array is described. The VOA array includes: a substrate; and a plurality of VOAs disposed on the substrate, where the plurality of VOAs have trenches therebetween, and a VOA in the plurality of VOAs includes: a phase change material (PCM) layer, where a state of the PCM layer is selectively in a crystalline state, an amorphous state, or a mixed state based on temperature of the PCM layer, and variation of the state of the PCM layer is used for adjusting an output power of an optical signal input into the VOA array; a controller disposed between the substrate and the PCM layer and configured to change the temperature of the PCM layer; and a mirror layer disposed between the controller and the PCM layer and configured to reflect the adjusted optical signal of the PCM layer.

Based on the VOA array according to the embodiments of the present disclosure, in one aspect, the speed of state change of the PCM layer may be on the order of nanoseconds, and thus the PCM-based VOA array may easily regulate the power of each channel with a speed of 1 ms or less, which is much higher than the speed of liquid crystal on silicon (LCoS) in regulating the power. In another aspect, PCM is insensitive to polarization and therefore the VOA array may not require polarization diversity design, thereby reducing the complexity of design and manufacturing.

In some embodiments, the VOA further includes an anti-reflection layer disposed at a side of the PCM layer facing away from the substrate, and the anti-reflection layer is configured to reduce light that does not pass through the PCM layer.

In this way, the anti-reflection layer is used to reduce reflected light from the optical signal input to the VOA array. The anti-reflection layer may allow as much of the optical signal as possible to enter the PCM layer, thereby increasing the range of power adjustment of the VOA array.

In some embodiments, the plurality of VOAs satisfy at least one of following conditions: at least two VOAs of the plurality of VOAs are configured to operate together at a spectral width corresponding to one spectral width suitable for the optical signal; or one VOA in the plurality of VOAs is configured to operate at a spectral width corresponding to one or more spectral widths suitable for the optical signal.

For example, there may be at least two of the plurality of VOAs operating at a spectral width corresponding to one spectral width of the optical signal. This fine-grained spectrum allocation and dynamic bandwidth adjustment may make the spectrum more efficient and may be suitable for scenarios that require fine configuration of power. In some other examples, one of the plurality of VOAs operates with a spectral width corresponding to one or more spectral widths of the optical signal. For example, the spectral width in which each VOA operates may correspond to a plurality of spectral widths of the optical signal. This approach may be applied to scenarios that do not require high accuracy in regulating the spectral width of the optical signal, which may have the advantage of simple operation, small control amount, and low cost. The specific choice of the approach mainly depends on the cost as well as the specific scenarios, and the above approach may enable the VOA array to achieve a more flexible adjustment of the power.

In some embodiments, the plurality of VOAs are arranged in M rows and N columns in a plane where the substrate is located, where both M and N are positive integers and at least one of M and N is greater than 1.

In this case, the VOA array may be one-dimensional or two-dimensional. The choice of the above VOA array arrangement mainly depends on the cost as well as the specific scenarios, which may provide different options for the power adjustment.

In some embodiments, the optical signal is divided into N spectral slices, the VOA array is used to adjust an output power of the N spectral slices, a VOA in an ith column of N columns of VOAs operates at a spectral width of an ith spectral slice of the N spectral slices to adjust an output power of the ith spectral slice, and i∈[1, N].

Based on this property of the PCM material, the optical signal input to the VOA array is divided into N spectral slices, and the one or more VOAs in the ith column are used to adjust the output power of the ith spectral slice, which may make full use of the optical properties of the PCM layer to achieve power adjustment for the optical signal in different spectral ranges respectively.

In some embodiments, M is greater than 1, the ith spectral slice is further divided into M spectral sub-slices, each VOA in the ith column of VOAs is used to adjust an output power of a corresponding one of the M spectral sub-slices, and the output power of the ith spectral slice is related to an output power of the M spectral sub-slices.

In this way, the output power of the ith first spectral slice depends on the output power of the M spectral sub-slices. Therefore, the regulation of the M spectral sub-slices may be achieved separately, further improving the flexibility of power adjustment. In addition, in a case where some PCMs need to be reset when their state changes, which may lead to discontinuities in the attenuation of the optical signal. By using the regulation of the M spectral sub-slices, the abrupt change may not affect the continuity of the attenuation of the ith spectral slice.

According to a second aspect, a power adjustment device is described. The power adjustment device includes: an input fiber port configured to receive an optical signal and transmit the optical signal to an imaging optical module; the imaging optical module configured to regulate an optical path of the optical signal, perform a spectral dispersion of the optical signal, and output the dispersed optical signal to a variable optical attenuator (VOA) array; the VOA array including a phase change material (PCM) layer for adjusting an output power of the dispersed optical signal and outputting the adjusted optical signal to the imaging optical module, where the imaging optical module is further configured to regulate an optical path of the adjusted optical signal, perform a spectral merging of the adjusted optical signal, and output the merged optical signal to an output fiber port; and the output fiber port configured to output the merged optical signal.

The power adjustment device may achieve power adjustment speeds on the order of 1 millisecond or less per channel. In addition, the VOA array in the power adjustment may not require a polarization diversity design, thereby reducing the complexity of design and manufacturing. In addition, the VOA array in the power adjustment may have a small amount of control, thereby avoiding wasting computational resources and costs.

In some embodiments, the imaging optical module includes: optical lenses configured to collimate and adjust a propagation direction of the optical signal; and an optical grating used for spectral dispersion and spectral merging of the optical signal.

In some embodiments, the power adjustment device further includes: a photodetector (PD) array configured to monitor a power of optical signal passing through the VOA array.

The PD array serves to provide real-time monitoring of the power of the optical signal in the VOA array. For example, a PD may be placed on a VOA, and because the optical signal on the VOA has a certain size, a PD may detect the power by the received optical signal. In this way, the power of the optical signal on each VOA may be detected in real time, which may further enable more precise adjustment of the power.

In some embodiments, the PD array is integrated with the VOA array.

In this case, low cost may be achieved.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 is an example point-point optical fiber communication system;

FIG. 2 is an example energy exchange between three wavelengths;

FIG. 3 is a structure of a wavelength selective switch (WSS) for channel power adjustment;

FIG. 4 is a structural diagram of a variable optical attenuator (VOA) array in accordance with some embodiments of the present disclosure;

FIG. 5 is a schematic diagram illustrating changes in optical properties of germanium antimony telluride (GST) in different states in accordance with some embodiments of the present disclosure;

FIG. 6 illustrates an extinction coefficient κ of GST materials as a function of wavelength of light and temperature;

FIG. 7 is a diagram illustrating an attenuation of a 100 nm thick GST film in a wavelength range of 1520 nm and 1630 nm calculated based on the extinction coefficient κ;

FIG. 8 is a structural diagram of another VOA array in accordance with some embodiments of the present disclosure;

FIG. 9 illustrates refractive indices n of GST in different states;

FIG. 10 illustrates an operating mode of a VOA array compatible with a flexible grid in accordance with some embodiments of the present disclosure;

FIG. 11 is a schematic diagram of distributions of VOAs in accordance with some embodiments of the present disclosure;

FIG. 12 is a schematic diagram of an optical signal input to the VOA array divided into N spectral slices in accordance with some embodiments of the present disclosure;

FIG. 13 is a structure diagram of a multi-pixel VOA array in accordance with some embodiments of the present disclosure;

FIG. 14 is a schematic diagram for attenuation discontinuity avoidance by a multi-pixel VOA array in accordance with some embodiments of the present disclosure;

FIG. 15 is a structure of a power adjustment device in accordance with some embodiments of the present disclosure; and

FIG. 16 is a structure of another power adjustment device in accordance with some embodiments of the present disclosure.

### DETAILED DESCRIPTION

Embodiments of the present disclosure are described below with reference to the accompanying drawings.

For ease of understanding, the technical terms involved in the embodiments are first described below.

### 1. Optical Fiber Communication System

An optical fiber communication system is a communication system that utilizes optical fibers as transmission media, and has the advantages of high bandwidth, low loss, and high interference immunity. Among optical fiber communication systems, a point-point optical fiber communication system is an optical fiber communication system that directly connects two communication terminals. It is designed to achieve high-bandwidth, high-speed data transmission and is typically used in data centers, high-speed network links, and telecommunication infrastructures.

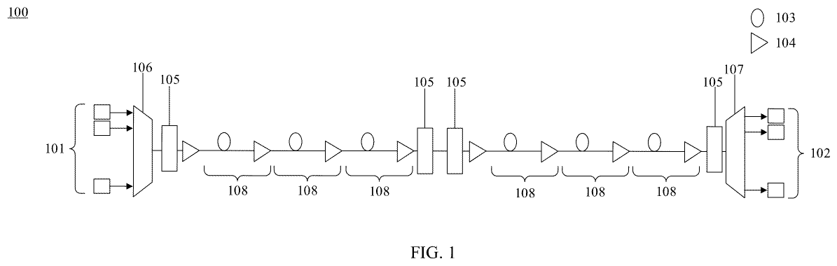

A typical point-point optical fiber communication system is shown in FIG. 1. As shown in FIG. 1, the point-point optical fiber communication system 100 includes transmitters (Txs) 101, receivers (Rxs) 102, a transmission fiber 103, optical amplifiers 104 for compensating losses due to the transmission fiber, wavelength selective switches (WSSs) 105, a multiplexer 106, a demultiplexer 107, and many other components not shown for simplicity. In the point-point optical fiber communication system 100, there are multiple wavelength channels (e.g., around 100 channels) going through the same transmission fiber 103 and the optical amplifiers 104. There are also multiple fiber spans 108 in cascade.

In the optical fiber communication system 100 shown in FIG. 1, one possible operating process is described below. Multiple optical signals of different wavelengths at the transmitters 101 pass through the multiplexer 106 of the wavelength division multiplexing (WDM) technology, which is capable of multiplexing the multiple optical signals of the different wavelengths into the single transmission fiber 103 for efficient transmission. The optical signals adjusted by the multiplexer 106 enters a WSS 105, which may convert the wavelengths of the input optical signals to other required wavelengths or change the direction of optical signal transmission according to the need, so as to realize the flexible conversion and transmission of the optical signals. The optical signals adjusted by the WSS 105 enter the optical amplifiers 104 in the multiple fiber spans in cascade to achieve gain of the optical signals. During transmission, the plurality of amplifiers 104 or another WSS 105 may further regulate the optical signals. The demultiplexer 107 separates the optical signals by wavelength and recovers and outputs the individual signals to the respective receivers 102.

### 2. Erbium Doped Fiber Amplifier (EDFA)'s Gain Coupling

In typical optical fiber communication systems, EDFAs are widely used to compensate fiber/component losses. For example, the EDFA may be the optical amplifier 104 in the optical fiber communication system 100 shown in FIG. 1. EDFAs are usually operated in constant average gain mode. As channel loading changes, the gain of channels that are not directly added/dropped (non-AD channels) may also change. For example, adding or dropping a channel may result in a change in the loading of the non-AD channels, which may further result in a change in the gain distribution of the EDFA, thereby affecting the power of the non-AD channels.

### 3. Stimulated Raman Scattering (SRS)

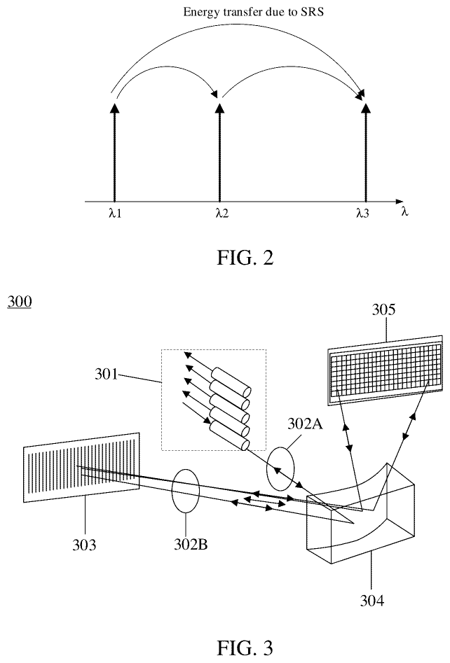

In silica based optical fiber, SRS may cause energy transfer from a shorter wavelength to a longer wavelength. FIG. 2 shows an example of energy exchange between three wavelengths. In system with more than three wavelengths, energy transfer may occur between any two wavelengths. SRS induced energy transfer depends on the channel power, channel separation, fiber type, and fiber length.

### 4. Channel Loading

In an optical fiber communication system, channels refer to signals transmitted simultaneously over different wavelengths or frequencies in the same fiber. In an optical fiber communication system, a channel loading refers to a number of channels, wavelengths of the channels and powers of the channels. Changes in channel loading (the number of channels and their wavelength locations) may be affected by a number of factors. For example, channel loading may vary due to intentional/un-intentional channel add/drop. Channels can be added/dropped on purpose (intentional), or due to fiber cut/device faults (un-intentional).

### 5. Phase Change Material (PCM)

PCM refers to a material that may change its physical state at a different temperature, for example, from a solid state to a liquid state, or from a crystalline state to an amorphous state.

### 6. Flex Grid

Conventional WDM systems typically use a fixed spectral spacing (e.g., 50 GHz or 100 GHz), which may lead to spectrum waste. Flex grid allows the spectrum spacing to be dynamically adjusted based on actual demand, thereby optimizing bandwidth allocation. Flex grid may support signals with different bandwidth requirements, e.g., a combination of signals that may only require a few tens of GHz and signals that may require a larger bandwidth. With flexible spectrum allocation, the WDM system may make more efficient use of fiber resources, which may improve the efficiency of spectrum utilization and adapt to multiple bandwidth requirements.

In the optical fiber communication system shown in FIG. 2, during the channel add/drop process, the non-AD channels may also experience power excursion due to two mechanisms (the EDFA's gain coupling and the SRS). Due to the power excursion, the performance of the non-AD channel may be significantly impacted, and thus the power of the non-AD channel needs to be adjusted to eliminate the power excursion of the non-AD channel as much as possible to avoid a significant performance degradation of the non-AD channel.

Considerable efforts have been made to reduce/tolerate the performance impact during channel add/drop, including EDFA optimization, its modeling, channel planning, channel power equalization, channel power adjustment, extra system design margin, etc.

A WSS for channel power adjustment is shown in FIG. 3. As shown in FIG. 3, the WSS 300 may include input/output fiber ports 301, optical lenses 302A and 302B, an optical grating 303, a cylindrical mirror 304, and a polarization sensitive liquid crystal on silicon (LCoS) 305. In addition to the wavelength routing capability, the WSS 300 may also have the per-channel/per-spectrum slice power adjustment capability, and the power adjustment process of the WSS 300 for optical signal is as follows. An input fiber port 301 receives an optical signal, the optical lens 302A collimates the optical signal, and the cylindrical mirror 304 reflects the collimated optical signal; the optical lens 302B collimates the adjusted optical signal, and the optical grating 303 performs spectral dispersion on the collimated optical signal; the optical lens 302B collimates the dispersed optical signal, and the cylindrical mirror 304 reflects the collimated optical signal; the adjusted optical signal enters the LCOS 305, which adjusts the power of the direction-adjusted optical signal and outputs it to the cylindrical mirror 304; the cylindrical mirror 304 reflects the power-adjusted optical signal and the optical lens 302B collimates the power-adjusted optical signal; the optical grating 303 performs spectral merging on the collimated optical signal; the optical lens 302B collimates the merged optical signal, and the cylindrical mirror 304 adjusts the direction of the collimated optical signal. The optical lens 302A collimates the adjusted optical signal. An output fiber port 301 receives the collimated optical signal and outputs it.

The WSS 300 shown in FIG. 3 may be applied in the optical fiber communication system 100 shown in FIG. 1 in order to adjust the power of the optical signals transmitted in FIG. 1 to avoid a significant degradation of the performance of the non-AD channel.

The WSS is typically based on the LCOS, and the switching or fading speed of the LCOS-based WSS is in the order of 100 millisecond (ms). With the development of technology, the LCOS-based WSS may be able to achieve the switching or fading speed of about 10 ms in the future. However, typical fiber failures are on the order of a few milliseconds or longer, so that power adjustment on the order of 1 ms or less per channel may be required, which means that the future LCOS-based WSSs are also slow and laggy for power adjustment, and therefore adjustments to the power to eliminate power excursion may be ineffective, further affecting the performance and user experience of optical fiber communication systems.

Therefore, how to quickly adjust the power per channel (to the order of 1 ms or even lower), and thus increase the speed of elimination of power excursion in non-AD channels during the channel add/drop process, is an urgent problem.

In view of this, embodiments of the present disclosure provide the following technical solutions. Embodiments of the present disclosure are described below with reference to the accompanying drawings.

PCM may have optical properties that change with its state. For example, in a case where the PCM changes from a crystalline state to an amorphous state, its optical parameters such as refractive index and extinction coefficient may change significantly. Because the speed of state change of the PCM may reach nanoseconds, PCM-based VOA arrays may achieve fast adjustment of power. In addition, the state change of the PCM is wavelength-dependent, and by taking advantage of this feature, per-channel/per-spectrum slice power tuning capability may be achieved easily.

Embodiments of the present disclosure provide a VOA array. The VOA array includes a PCM layer, and thus the VOA array may adjust the power of an input optical signal based on the PCM layer. In one aspect, the speed of state change of the PCM may be on the order of nanoseconds, and thus the PCM-based VOA array may easily regulate the power of each channel with a speed of 1 ms or less, which is much higher than the speed of LCOS in regulating the power. In another aspect, PCM is insensitive to polarization and therefore the VOA array may not require polarization diversity design, reducing the complexity of design and manufacturing.

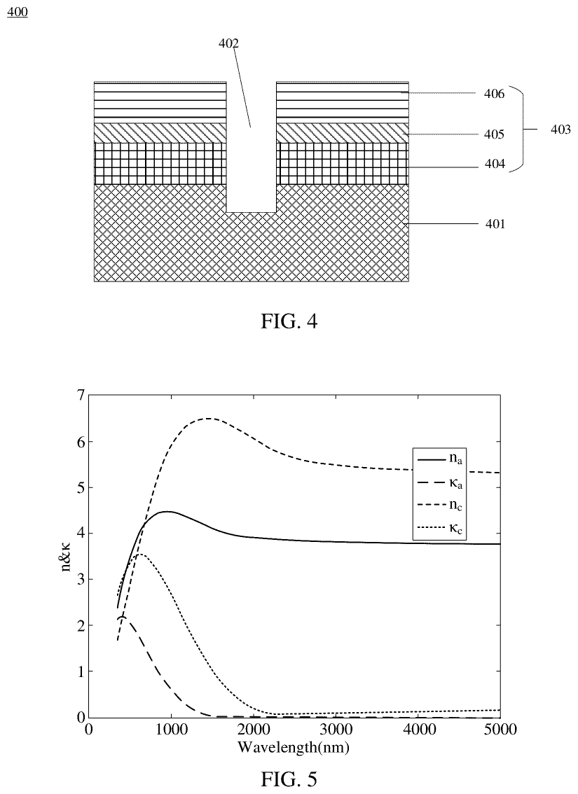

FIG. 4 shows a structural diagram of a variable optical attenuator (VOA) array in accordance with some embodiments of the present disclosure. For simplicity, only two VOAs are shown.

As shown in FIG. 4, the VOA array 400 includes a substrate 401 and two VOAs 403 disposed on the substrate 401. The two VOAs have a trench 402 therebetween, and each VOA 403 includes a controller 404, a PCM layer 406, and a mirror layer 405.

For example, the substrate 401 is made of silica. The silica may have better corrosion resistance and remain stable under a wide range of environmental conditions. Therefore, the lower coefficient of thermal expansion of silica may help to maintain dimensional stability during temperature changes. In addition, according to different scenarios, the substrate 401 may also be made of other common materials such as ceramic, polyimide (PI), or the like. It is noted that the material of the substrate 401 is not limited thereto.

The substrate 401 has main functions of providing: physical support to maintain the shape and stability of the VOA array to ensure precise optical alignment; and heat conduction, because the substrate 401 may help dissipate the heat generated by the controller 404 during operation to prevent damage to the VOA array 400.

For example, the controller 404 may be a heater, which may be made of platinum, metal films (e.g., aluminum and tungsten), or other conductive polymers, and the material of the heater is not limited thereto. For another example, the controller 404 may be a laser, which may generate short laser pulses, thus providing heat. The kind of the controller 404 is not limited thereto.

The controller 404, as an important component of the VOA array, mainly serves to achieve state control of the PCM layer 406. For example, the temperature of the PCM layer 406 may be accurately controlled by adjusting the current in the controller 404 (such as a heater), so as to realize the change of the phase transition of the PCM layer 406, which may realize the control of the degree of attenuation of the light intensity, and ultimately realize the adjustment of the power.

For example, the mirror layer 405 may be made of a metal, such as transparent conductive oxide (TCO), gold, silver, aluminum, or other dielectric materials, such as silica and magnesium fluoride, and the material of the mirror layer 405 is not limited thereto.

The mirror layer 405 has a main function of outputting a modulated optical signal outside the VOA array, where the optical signal may have a certain degree of attenuation due to the passage of the PCM layer 406, which in turn produces a certain degree of change in the power. The mirror layer 405 is used to reflect the modulated optical signal out of the VOA array, thereby completing the process of power adjustment.

The trench 402 has a main function of isolating heat. If the width of the trench 402 in the direction in which the VOAs are arranged is too narrow, heat transfer from a VOA to an adjacent VOA may occur when different VOAs are operating, thus affecting power adjustment. If the width of the trench 402 is too wide, the size of the entire VOA array may be too large, incurring unnecessary costs. Therefore, width of the trench 402 needs to take the above factors into account.

For example, in the VOA array shown in FIG. 4, the PCM layer 406 may be made of germanium antimony telluride (GST), or other PCMs having the same or similar properties, and the material of the PCM layer 406 is not limited thereto.

For ease of understanding, the optical properties of the PCM layer 406 are described below with reference to FIG. 5 using the example of the PCM layer 406 being made of GST.

FIG. 5 is a schematic diagram illustrating changes in optical properties of GST in different states in accordance with some embodiments of the present disclosure. Due to the temperature change, a refractive index n and an extinction coefficient κ of GST in the amorphous and crystalline states change accordingly. In addition, the refractive index n and the extinction coefficient κ are also related to the wavelength of light. The extinction coefficient κ reflects the capability of the material to absorb light. The larger the value of the extinction coefficient κ, the greater the attenuation of light intensity in the material.

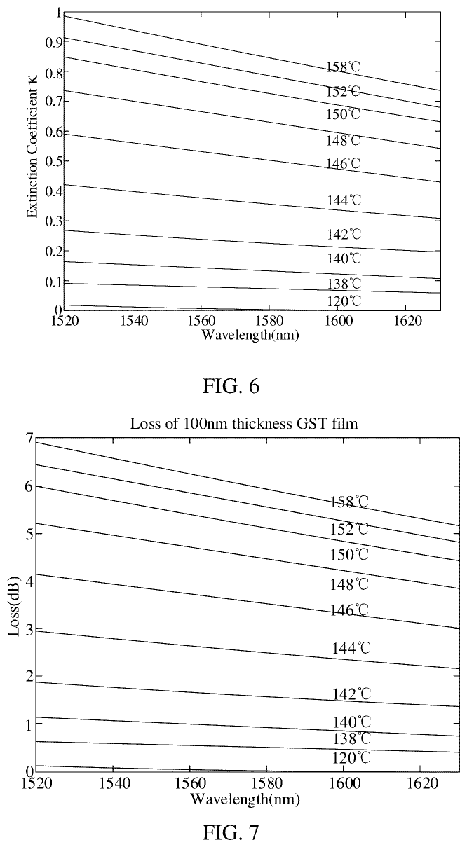

In addition to temperature, the degree of attenuation of light intensity may also be related to the wavelength of light, and FIG. 6 shows extinction coefficient κ of GST materials as a function of wavelength of light and temperature. The relationship between the loss coefficient of light intensity α, the wavelength of light λ and the extinction coefficient κ of GST may be given as:

$$α = 4 πκ / λ . \qquad ( 1 )$$

In a case where the PCM layer 406 is a GST film, the GST film may have a thickness of about 100 nm. FIG. 7 is a diagram illustrating an attenuation of a 100 nm thick GST film in a wavelength range of 1520 nm and 1630 nm calculated based on the extinction coefficient κ shown in FIG. 6. As can be seen from FIG. 7, power loss may range from almost negligible to higher than 5 decibels (dB) at different wavelengths and different temperatures. In the embodiments of the present disclosure, the VOA arrays may be placed in the same position as amplifiers, and a VOA array may act on only one span. Due to the EDFA's gain coupling and the SRS effect of the optical fiber, the gain change may only be less than a few dB (e.g., 2 dB or 3 dB) per fiber span, which means that this modulation range may be sufficient.

As shown in FIG. 7, the degree of attenuation of the optical signal by GST may also be affected by the wavelength of light. The embodiments of the present disclosure may make use of this property of the PCM material to achieve more precise regulation by separately regulating the power of the optical signal in different spectral ranges.

The PCM layer 406 may serve as a core component of the VOA array, and its main function is to adjust power of the optical signal quickly. For example, when the optical signal passes through the PCM layer 406, the temperature of the PCM layer 406 may be changed to change the state of the PCM layer 406. Accordingly, the extinction coefficient κ of the PCM layer 406 is changed (the change is also related to the wavelength of the light), such that loss of light intensity at different wavelengths may be changed to different degrees. In addition, because the speed of change in the state of the PCM layer 406 can be on the order of nanoseconds, rapid adjustment of the power in different spectral ranges may be achieved.

In summary, for the PCM-based VOA array according to the embodiments of the present disclosure, the power adjustment speed of the VOA array for each channel may be easily achieved in the order of 1 ms or lower, thereby eliminating the power excursion during channel add/drop as much as possible. In addition, VOA arrays may not require polarization diversity design, thereby reducing the complexity of design and manufacturing. In addition, VOA arrays may be one-dimensional arrays compared to large-scale two-dimensional arrays of LCOS. Therefore, VOA arrays may need less control and require less signal bandwidth, thereby avoiding the waste of computational/communication resources and cost.

In some embodiments, the VOA array further includes an anti-reflection layer disposed at a side of the PCM layer facing away from the substrate, and the anti-reflection layer is configured to reduce light that does not pass through the PCM layer.

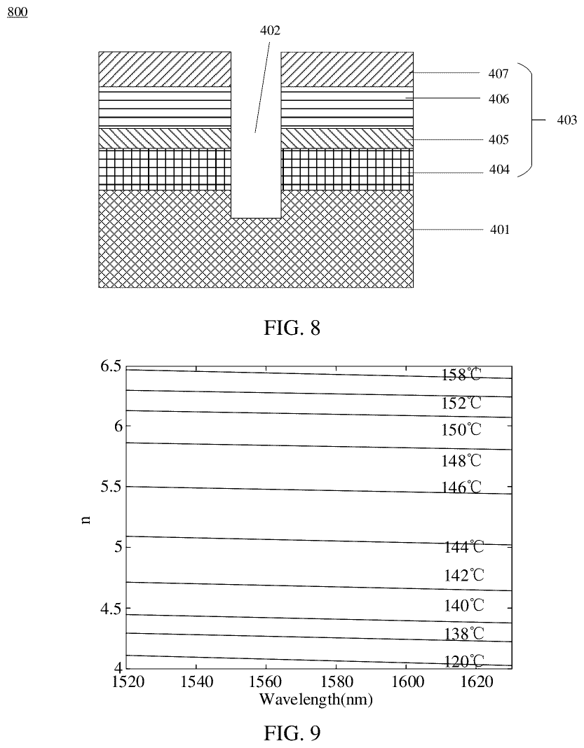

FIG. 8 shows a structural diagram of the VOA array. As shown in FIG. 8, the anti-reflection layer 407 is disposed on a side of the PCM layer 406 facing away from the mirror layer 405. The anti-reflection layer 407 may be made of silicon dioxide, magnesium fluoride, calcium fluoride, or other polymeric materials (e.g., polymethyl methacrylate, PMMA) or a multilayer film material, and the material of the anti-reflection layer 407 is not limited thereto.

The anti-reflection layer 407 is used to reduce reflected light from the optical signal input to the VOA array. The anti-reflection layer 407 allows as many optical signals as possible to enter the PCM layer 406, thereby increasing the range of power adjustment of the VOA array.

For example, the refractive indices n of GST in different states are shown in FIG. 9. As can be seen from FIG. 9, the refractive index of GST may be as high as 6.5 at a higher temperature. At an air-GST interface, the reflectivity may be calculated to be 0.5378 according to the refractive index of GST which is 6.5. This means that more than 50% of the optical signal is directly output by reflection at the air-GST interface in a case where the anti-reflection layer 407 is not present, which may greatly affect the overall attenuation of the optical signal and reduce the range of power adjustment by the VOA array.

In some possible scenarios, a thickness of the anti-reflection layer 407 is ¼ of the wavelength of the optical signal input to the VOA array (i.e., λ/4). The refractive index of the anti-reflection layer 407 is the square root of a product of refractive indices of its two neighboring interlayers. Because the anti-reflection layer 407 is located between air and GST, the refractive index of the antireflective layer 407 is:

$${n}_{AR} = \sqrt{{n}_{PCM}} . \qquad ( 2 )$$

Where n_{AR} is the refractive index of the anti-reflection layer 407, and n_{PCM} is the refractive index of the PCM layer 406 (e.g., GST).

The refractive index of the PCM layer 406 is not constant, and it may change as the state of the PCM layer 406 changes. Therefore, different anti-reflection layers 407 may be selected according to specific scenarios. For example, if there is a need to reduce the insertion loss of the PCM layer 406 when it is in an amorphous state, the GST in the amorphous state may have a refractive index of about 4.1, and in this case, the refractive index of the anti-reflection layer 407 is 2.02.

In this case, an electric field of reflected light at an interface between the anti-reflection layer 407 and air may be coherently superimposed with an electric field of reflected light at an interface between the anti-reflection layer 407 and the PCM layer 406. Due to the reflection described above, the optical signal entering the PCM layer 406 has a loss compared to the initial optical signal, and the loss is calculated as:

$${R}_{dB} \approx 10 * log 10 {( \frac{1 - 2.02}{1 + 2.02} - \frac{2.02 - 6.5}{2.02 + 6.5} )}^{2} = - 1 4.6 dB . \qquad ( 3 )$$

This value indicates that only a small amount of the initial optical signal is lost due to reflection (approximately 3.5% of the initial optical signal), and that the vast majority of the initial optical signal enters the PCM layer 406, through which the optical signal may be further modulated. In summary, the anti-reflection layer 407 may allow as much of the optical signal as possible to enter the PCM layer 406, thereby increasing the range of power adjustment of the VOA array.

In some embodiments, the plurality of VOAs satisfy at least one of following conditions: at least two VOAs of the plurality of VOAs are configured to operate together at a spectral width corresponding to one spectral width suitable for the optical signal; or one VOA in the plurality of VOAs is configured to operate at a spectral width corresponding to one or more spectral widths suitable for the optical signal.

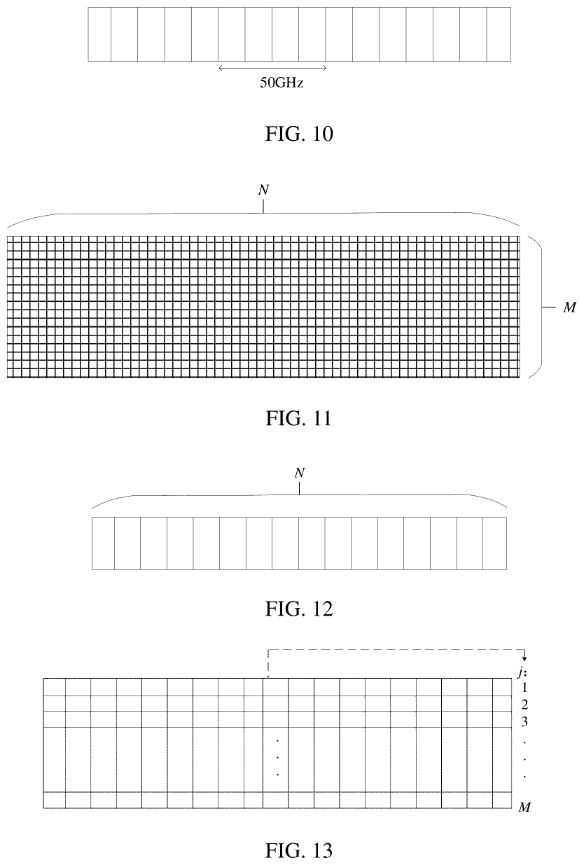

In this case, the VOA arrays may be compatible with a flex grid, which may enable more flexible adjustment of power. In some examples, at least two of the plurality of VOAs are configured to operate together at a spectral width corresponding to one spectral width suitable for the optical signal. For example, each VOA operates with a spectral width finer than the spectral width of the optical signal. An example operating mode of a VOA array compatible with a flex grid is shown in FIG. 10. As shown in FIG. 10, the one spectral width of the optical signal is 50 GHz, and 4 VOAs operate together at this spectral width. In this case, each VOA may operate at a spectral width of 12.5 GHZ. This fine-grained spectrum allocation and dynamic bandwidth adjustment may make the spectrum more efficient and may be suitable for scenarios that require fine configuration of power. It is noted that although FIG. 10 illustrates a spectral width of 50 GHz, the spectral width may also be 25 GHZ, 12.5 GHZ, 6.25 GHz, 3.125 GHZ, etc.

In some other examples, one of the plurality of VOAs is configured to operate at a spectral width corresponding to one or more spectral widths suitable for the optical signal. For example, the spectral width in which each VOA operates may correspond to one spectral width of the optical signal. For another example, the spectral width in which each VOA operates may correspond to a plurality of spectral widths of the optical signal. And this approach may be applied to scenarios that do not require high accuracy in regulating the spectral width of the optical signal, which may have the advantage of simple operation, small control amount, and low cost.

Which scheme to choose mainly depends on the cost as well as the specific scenarios, and the above scheme may enable the VOA array to achieve a more flexible adjustment of the power.

In some embodiments, the plurality of VOAs are arranged in M rows and N columns in a plane where the substrate is located, as shown in FIG. 11, where both M and N are positive integers and at least one of M and N is greater than 1.

In some examples, the VOA array may be a one-dimensional array. For example, M=1, and N>1. All of the VOAs in the VOA array are in the same row. A VOA may operate at a spectral width that corresponds to one or more spectral widths of the optical signal, or a plurality of VOAs may operate at a spectral width that corresponds to one spectral width of the optical signal. In this way, low cost and simple operation may be achieved.

In some other examples, the VOA array may be a two-dimensional array. For example, M>1, and N>1. In this case, there exists a plurality of VOAs in each row and each column. VOAs in each column may operate at a same spectral width, and the VOAs perform power adjustment on the input optical signal separately. In this way, more accurate power adjustment of the optical signal may be achieved.

It is noted that, compared with LCOS, regardless of whether the VOA array is a one-dimensional array or a two-dimensional array, the number of units (each of which may refer to a LCOS unit in the LCOS or a VOA in the VOA array) that need to be controlled during the operation of the VOA array is much smaller than that of LCOS. As a large-scale two-dimensional array, LCOS may need to control several thousand units in each row or column, and the array of this size has high requirements for the bandwidth of the control signal. This is one of the reasons why LCOS cannot adjust power quickly. However, in the VOA array provided in embodiments of the present disclosure, only one or a few VOAs may need to be controlled in each row or column. For example, even if the VOA array is a two-dimensional array, for the M VOAs in an ith column, the power of these M VOAs does not need to be controlled independently. For example, a timing circuit may be used to regulate M VOAs in an ith column integrally without controlling each VOA in M VOAs in the ith column individually, thus reducing the amount of control, requiring less signal bandwidth, and avoiding wasting computational/communication resources and costs.

The choice of the above VOA array arrangement mainly depends on the cost as well as the specific scenarios, and the above scheme provides different options for the power adjustment.

In some embodiments, the optical signal input to the VOA array may be divided into N spectral slices, the VOA array is used to adjust an output power of the N spectral slices, a VOA in an ith column of N columns of VOAs operates at a spectral width of an ith spectral slice of the N spectral slices to adjust an output power of the ith spectral slice, and i∈[1, N].

FIG. 12 is a schematic diagram of an optical signal input to the VOA array divided into N spectral slices. As shown in FIG. 12, the horizontal axis may represent the wavelength of the optical signal and the vertical axis may represent position of the VOA array in a direction perpendicular to the column direction. The VOA array may be configured to adjust an output power of each N spectral slice. In this case, one or more VOAs in an ith column of N columns of VOAs operate at a spectral width of an ith spectral slice of the N spectral slices to adjust an output power of the ith spectral slice.

As mentioned earlier, the degree of attenuation of light by the PCM layer 406 may also be affected by the wavelength of the light. Based on this property of the PCM material, the optical signal input to the VOA array is divided into N spectral slices, and the one or more VOAs in the ith column are used to adjust the output power of the ith spectral slice, which may make full use of the optical properties of the PCM layer 406 to achieve power adjustment for the optical signal in different spectral ranges respectively.

In some embodiments, M is greater than 1, the ith spectral slice is further divided into M spectral sub-slices, each VOA in the ith column of VOAs is used to adjust an output power of a corresponding one of the M spectral sub-slices, and the output power of the ith spectral slice is related to an output power of the M spectral sub-slices.

In this case, one VOA may be regarded as a pixel, and a multi-pixel VOA array is shown in FIG. 13.

For example, because each VOA in the ith column of VOAs may be used to adjust the output power of a corresponding one of the M spectral sub-slices, the output power of the ith spectral slice may be a weighted sum of the output powers of the M spectral sub-slices. In an implementation, the output power of the ith spectral slice may be given as:

$$I = {\vert {\sum }_{j = 1}^{M} {E}_{j} {e}^{i \frac{2 π}{λ} ( {n}_{j} ( {T}_{j} ) + i {κ}_{j} ( {T}_{j} ) ) * 2 d} \vert}^{2} . \qquad ( 4 )$$

Where nⱼ(Tⱼ) and κⱼ(Tⱼ) are respectively the refractive index n and extinction coefficient κ of the VOA in the jth row in ith column. Et is the electric field, T is the heating temperature, and d is the thickness of the PCM layer 406.

In the above multi-pixel VOA array, the output power of the ith spectral slice depends on the output powers of the M spectral sub-slices. Therefore, the regulation of the M spectral sub-slices may be achieved separately, further improving the flexibility of power adjustment.

It is noted that, states of some PCMs may change. For example, a PCM in a mixed state (i.e., partly crystalline and partly amorphous) is first reset to the amorphous state, and then the reset PCM is changed to another mixed state (e.g., the ratio of the crystalline state to the amorphous state is changed). When the states of the PCMs change, the PCMs may need to be reset. For example, for a certain PCM which is in a mixed state, if it is necessary to adjust the PCM to another mixed state, a resetting process may be required. The reset may lead to discontinuities in the attenuation of the optical signal.

However, in the multi-pixel VOA array shown in FIG. 13, power adjustment may be implemented separately for each spectral sub-slice. In a case where a VOA is utilized to attenuate the light intensity of the jth spectral sub-slice of the M spectral sub-slices, although the attenuation of the jth spectral sub-slice may have undergone an abrupt change, the attenuation of the ith spectral slice depends on the overall attenuation of the M spectral sub-slices, and thus the abrupt change may not affect the continuity of the attenuation of the ith spectral slice.

A schematic diagram illustrating attenuation discontinuity avoidance by a multi-pixel VOA array is shown in FIG. 14. By adjusting the M spectral sub-slices individually, it is possible to control the overall attenuation of the M spectral sub-slices. As a result, the attenuation of the ith spectral slice may be substantially continuous in time, thereby avoiding a discontinuity in the attenuation of the optical signal.

The VOA array according to the embodiments of the present disclosure may be applied to regulate powers of optical signals in per channel/spectrum with a speed of 1 ms or less. It may also be applied in other scenarios that may not require high power regulation speed or spectral accuracy, and the application scenarios of the VOA array are not limited thereto.

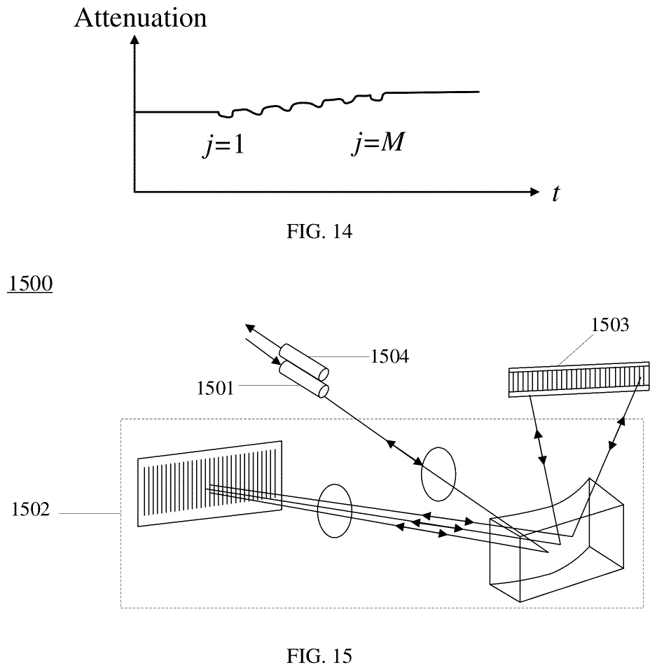

FIG. 15 illustrates a structure of a power adjustment device according to some embodiments of the present disclosure. Compared with the WSS shown in FIG. 3, the power adjustment device 1500 shown in FIG. 15 utilizes PCM-based VOA arrays in place of LCOS, which may allow for power adjustment of the optical signal input to the power adjustment device 1500 to be performed at a power adjustment speed of 1 millisecond or a lower order of magnitude, thereby eliminating the power excursion as much as possible during channel add/drop. Because the VOA array does not require a polarization diversity design, the complexity of the overall design and manufacturing of the power adjustment device 1500 may be reduced. In addition, compared to the large-scale 2D array LCOS, VOA arrays may require less control and lower signal bandwidth requirements. In this way, the power adjustment device 1500 may avoid wasting of computational resources and costs.

The power adjustment device 1500 includes at least one input fiber port 1501, an imaging optical module 1502, a VOA array 1503, and at least one output fiber port 1504.

The input fiber port 1501 may include a housing material (e.g., metal or plastic), a fiber optic connector (e.g., ceramic or plastic), and a sealing material (e.g., rubber or silicone). The input fiber port 1501 is used to receive an optical signal and transmit the optical signal to the imaging optical module 1502. The at least one input fiber port 1501 may include one or more input fiber ports 1501, e.g., two, three, etc., input fiber ports 1501.

The imaging optical module 1502 may include an optical grating and optical lenses. The optical lenses are used to adjust a propagation path of the optical signal, in addition to collimating the optical signal. The optical grating may perform spectral dispersion of the optical signal, and the optical grating may also perform spectral merging of the optical signal adjusted by the VOA array 1503.

The structure and function of the VOA array 1503 are as previously described and will not be repeated here.

The output fiber port 1504 may include a housing material (e.g., metal or plastic), a fiber optic connector (e.g., ceramic or plastic) and a sealing material (e.g., rubber or silicone). The output fiber port 1504 is used to output the adjusted optical signal.

The at least one output fiber port 1504 may include one or more output fiber ports 1504, e.g., two, three, etc., output fiber ports 1504. In a case where the at least one output fiber port 1504 includes one output fiber port, the angle of the VOA array 1503 may be calibrated during the manufacturing process. In this way, the VOA array may not need to be controlled for angular changes during the operation of the power adjustment device 1500, which may make the operation easier and the control cost low.

The process of power adjustment of the optical signal by the power adjustment device 1500 may be as follows: the input optical fiber port 1301 receives the optical signal and transmits the optical signal to the imaging optics module 1502; optical lenses in the imaging optics module 1502 collimate and direct the transmission direction of the optical signal; the optical grating performs spectral dispersion on the adjusted optical signal; the optical lenses in the imaging optical module 1502 collimate the dispersed optical signal and direct the transmission direction; the directed optical signal enters the VOA array 1503, which regulates the power of the optical signal and outputs the optical signal to the imaging optical module 1502; the imaging optical module 1502 collimates the power-regulated optical signal and directs the transmission direction; and the optical grating spectrally combines the directed optical signal, where the optical grating and the above-mentioned optical grating for spectral dispersion may be the same optical grating or different optical gratings; optical lenses in the imaging optical module 1502 collimate and direct the transmission direction of the combined optical signal; and the optical fiber output port 1504 receives and outputs the directed optical signal.

Compared to the WSS shown in FIG. 3, the power adjustment device 1500 shown in FIG. 15 may achieve power adjustment speeds on the order of 1 millisecond or less per channel. Compared to the LCOS of FIG. 3, the VOA array of FIG. 15 may not require a polarization diversity design, reducing the complexity of design and manufacturing. In addition, compared to LCOS, the VOA array may have a small amount of control, avoiding wasted computational resources and costs.

The power adjustment device 1500 according to the embodiments of the present disclosure may be applied in an optical fiber communication system, for example in the optical fiber communication system shown in FIG. 2, which means that the power adjustment device 1500 may take the place of any of the WSSs shown in FIG. 2. Further, the other WSSs shown in FIG. 2 may have the structure shown in FIG. 3.

In some embodiments, the power adjustment device 1500 further includes a photodetector (PD) array configured to monitor a power of optical signal passing through the VOA array.

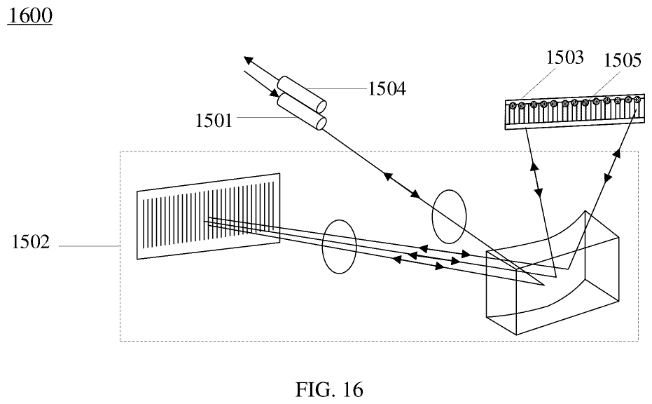

FIG. 16 shows a structural diagram of another power adjustment device according to some embodiments of the present disclosure. The power adjustment device 1600 further includes a PD array 1505.

For example, the PD array 1505 may include photodetector units (e.g., silicon photodiodes, photomultiplier tubes), readout circuitry (e.g., amplifier circuitry, analogue-to-digital conversion circuitry), a control system (e.g., a microcontroller or FPGA), and an interface and communication module.

The PD array 1505 may be used to provide real-time monitoring of the power of the optical signal in the VOA array 1503. For example, a PD in the PD array 1505 may be placed corresponding to a VOA. Because the optical signal on the VOA has a certain size, the PD may detect the power by the received optical signal. In this way, the power of the optical signal on each VOA may be detected in real time, which may further enable more precise adjustment of the power.

It is noted that the PD array 1505 may be integrated with the VOA array 1503, which may achieve low cost. The PD array 1505 may also be placed separately from the VOA array 1503. For example, the PD array 1505 may be placed on top of the VOA array 1503, in order to satisfy the needs of some special scenarios. Of course, the PD array 1505 may be placed in another place, as long as it can monitor the power of the optical signal in the VOA array 1503.

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

In the present disclosure, the terms “a”, “an” and “one” are defined to mean “at least one”, that is, these terms do not exclude a plural number of items, unless stated otherwise.

Unless the context requires otherwise, throughout the description and the claims, the term “comprise” and other forms thereof such as the third-person singular form “comprises” and the present participle form “comprising” are construed as open and inclusive meanings, i.e., “including, but not limited to”. In the description, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or examples(s). In addition, the specific features, structures, materials or characteristics may be included in any one or more embodiments or examples in any suitable manner.

Hereafter, the terms “first” and “second” are used for descriptive purposes only, and are not to be construed as indicating or implying the relative importance or implicitly indicating the number of indicated technical features. Thus, a feature defined with “first” or “second” may explicitly or implicitly include one or more of the features. In the description of the embodiments of the present disclosure, the terms “a/the plurality of” and “multiple” means two or more unless otherwise specified.

In the description of some embodiments, the terms “coupled” and “connected” and derivatives thereof may be used. For example, the term “connected” may be used in the description of some embodiments to indicate that two or more components are in direct physical or electrical contact with each other. For another example, the term “coupled” may be used in the description of some embodiments to indicate that two or more components are in direct physical or electrical contact. However, the term “coupled” may also mean that two or more components are not in direct contact with each other, but still cooperate or interact with each other. The embodiments disclosed herein are not necessarily limited to the content herein.

In the present disclosure, “at least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” usually indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes A, B, C, A and B, A and C, B and C, or A, B, and C, and “at least one of A, B, and C” may also be understood as including A, B, C, A and B, A and C, B and C, or A, B, and C.

In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

It is noted that the method may also include other well-known method for forming other components, layers or elements, which are not illustrated or described in detail to avoid obscuring pertinent aspects of the embodiments described herein.

It should be understood that in the various embodiments of the present disclosure, the size of the serial numbers of the above-mentioned processes does not mean the order of execution, and the order of execution of each process shall be determined by its function and internal logic, and shall not constitute any limitation on the implementation of the embodiments of the present disclosure.

The foregoing descriptions are merely specific implementations of the present disclosure, but the protection scope of the present disclosure is not limited thereto. Any changes or replacements that a person skilled in the art could readily conceive of within the technical scope of the present disclosure shall be included in the protection scope of the present disclosure. Therefore, the protection scope of the present disclosure shall be subject to the protection scope of the claims. Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

What is claimed is:

1. A variable optical attenuator (VOA) array comprising:
a substrate; and
a plurality of VOAs disposed on the substrate, wherein the plurality of VOAs have trenches therebetween, and a VOA in the plurality of VOAs comprises:
a phase change material (PCM) layer, wherein a state of the PCM layer is selectively in a crystalline state, an amorphous state, or a mixed state based on temperature of the PCM layer, and variation of the state of the PCM layer is used for adjusting an output power of an optical signal input into the VOA array;
a controller disposed between the substrate and the PCM layer and configured to change the temperature of the PCM layer; and
a mirror layer disposed between the controller and the PCM layer and configured to reflect the adjusted optical signal of the PCM layer.

2. The VOA array of claim 1, wherein the VOA further comprises an anti-reflection layer disposed at a side of the PCM layer facing away from the substrate, and the anti-reflection layer is configured to reduce light that does not pass through the PCM layer.

3. The VOA array of claim 1, wherein the plurality of VOAs satisfy at least one of following conditions:
at least two VOAs of the plurality of VOAs are configured to operate together at a spectral width corresponding to one spectral width suitable for the optical signal; or
one VOA in the plurality of VOAs is configured to operate at a spectral width corresponding to one or more spectral widths suitable for the optical signal.

4. The VOA array of claim 1, wherein the plurality of VOAs are arranged in M rows and N columns in a plane where the substrate is located, wherein both M and N are positive integers and at least one of M and N is greater than 1.

5. The VOA array of claim 4, wherein the optical signal is divided into N spectral slices, the VOA array is used to adjust an output power of the N spectral slices, a VOA in an ith column of N columns of VOAs operates at a spectral width of an ith spectral slice of the N spectral slices to adjust an output power of the ith spectral slice, and i∈[1, N].

6. The VOA array of claim 5, wherein M is greater than 1, the ith spectral slice is further divided into M spectral sub-slices, each VOA in the ith column of VOAs is used to adjust an output power of a corresponding one of the M spectral sub-slices, and the output power of the ith spectral slice is related to an output power of the M spectral sub-slices.

7. A power adjustment device comprising:
an input fiber port configured to receive an optical signal and transmit the optical signal to an imaging optical module;
the imaging optical module configured to regulate an optical path of the optical signal, perform a spectral dispersion of the optical signal, and output the dispersed optical signal to a variable optical attenuator (VOA) array;
the VOA array comprising a phase change material (PCM) layer for adjusting an output power of the dispersed optical signal and outputting the adjusted optical signal to the imaging optical module, wherein the imaging optical module is further configured to regulate an optical path of the adjusted optical signal, perform a spectral merging of the adjusted optical signal, and output the merged optical signal to an output fiber port; and
the output fiber port configured to output the merged optical signal.

8. The power adjustment device of claim 7, wherein the VOA array comprises:
a substrate; and
a plurality of VOAs disposed on the substrate, wherein the plurality of VOAs have trenches therebetween, and a VOA of the plurality of VOAs comprises:
a phase change material (PCM) layer, wherein a state of the PCM layer is selectively in a crystalline state, an amorphous state, or a mixed state based on temperature of the PCM layer, and variation of the state of the PCM layer is used for adjusting an output power of an optical signal input into the VOA array;
a controller disposed between the substrate and the PCM layer and configured to change the temperature of the PCM layer; and
a mirror layer disposed between the controller and the PCM layer and configured to reflect the adjusted optical signal of the PCM layer.

9. The power adjustment device of claim 7, wherein the VOA further comprises an anti-reflection layer disposed at a side of the PCM layer facing away from the substrate, and the anti-reflection layer is configured to reduce light that does not pass through the PCM layer.

10. The power adjustment device of claim 7, wherein the plurality of VOAs satisfy at least one of following conditions:
at least two VOAs of the plurality of VOAs are configured to operate together at a spectral width corresponding to one spectral width suitable for the optical signal; or
one VOA in the plurality of VOAs is configured to operate at a spectral width corresponding to one or more spectral widths suitable for the optical signal.

11. The power adjustment device of claim 7, wherein the plurality of VOAs are arranged in M rows and N columns in a plane where the substrate is located, wherein both M and N are positive integers, and at least one of M and N is greater than 1.

12. The VOA array of claim 11, wherein the optical signal is divided into N spectral slices, the VOA array is used to adjust an output power of the N spectral slices, a VOA in an ith column of N columns of VOAs operates at a spectral width of an ith spectral slice of the N spectral slices to adjust an output power of an ith spectral slice of the N spectral slices, and i∈[1, N].

13. The VOA array of claim 12, wherein M is greater than 1, the ith spectral slice is further divided into M spectral sub-slices, each VOA in the ith column of VOAs is used to adjust an output power of a corresponding one of the M spectral sub-slices, and the output power of the ith spectral slice is related to an output power of the M spectral sub-slices.

14. The power adjustment device of claim 7, wherein the imaging optical module comprises:
optical lenses configured to collimate and adjust a propagation direction of the optical signal; and
an optical grating used for spectral dispersion and spectral merging of the optical signal.

15. The power adjustment device of claim 7, further comprising:
a photodetector (PD) array configured to monitor a power of an optical signal passing through the VOA array.

16. The power adjustment device of claim 15, wherein the PD array is integrated with the VOA array.
